(19) United States
(12) Patent Application Publication
(10) Pub. No.: US 2010/0150824 A1
(43) Pub. Date: Jun. 17, 2010

(54) HYDROGEN GENERATOR WITH REACTANT DILUTION SCHEME

(75) Inventors: Sandra Withers-Kirby, College Station, TX (US); Jady Stevens, Bryan, TX (US); Mahavir Nagaraj, Spring, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Lynntech, Inc.

(21) Appl. No.: 12/623,088

(22) Filed: Nov. 20, 2009

Related U.S. Application Data
(60) Provisional application No. 61/117,023, filed on Nov. 21, 2008.

(51) Int. Cl. B01J 15/00; B01J 19/00; C01B 3/02

(52) U.S. Cl. 423/648.1; 422/164; 422/129

(57) ABSTRACT

A hydrogen generator (201) is provided which comprises (a) a chamber (205) having a hydrogen-containing material (213) disposed therein; (b) a first fluidic pathway (241) containing said chamber, said first fluidic pathway including an upstream portion which is upstream of said chamber, and a downstream portion which is downstream from said chamber; (c) a second fluidic pathway (243) which does not include said chamber, and which is adjoined to said first fluidic pathway downstream from said chamber; and (d) a reservoir (203) containing a liquid medium in which said hydrogen-containing material is soluble, said reservoir being in fluidic communication with at least one of said first and second fluidic pathways.

### CROSS REFERENCE TO RELATED APPLICATION

This application claims the benefit of priority from U.S. Application No. 61/117,023, filed Nov. 21, 2009, having the same title, and having the same inventors, and which is incorporated herein by reference in its entirety.

### FIELD OF THE DISCLOSURE

The present disclosure relates generally to hydrogen generators, and more particularly to hydrogen generators equipped with a reactant dilution scheme.

### BACKGROUND OF THE DISCLOSURE

Hydrogen generators are devices that generate hydrogen gas for use in fuel cells, combustion engines, and other devices, often through the evolution of hydrogen gas from chemical hydrides, borohydrides, boranes, or other hydrogen-containing materials. Sodium borohydride (NaBH₄) has emerged as a particularly desirable chemical hydride for use in such devices, due to the molar equivalents of hydrogen it generates (see EQUATION 1 below), the relatively low mass of NaBH₄ as compared to some competing materials, and the controllability of the hydrogen evolution reaction:

NaBH₄+2H₂O [symbol] NaBO₂+4H₂ (EQUATION 1)

The hydrolysis of sodium borohydride as a method of generating hydrogen gas has received considerable interest in the art, due in part to the high gravimetric storage density of hydrogen in this material and to the ease with which a pure hydrogen stream may be created from the hydrolysis reaction. However, despite these advantages, the commercial implementation of hydrogen generators based on sodium borohydride has encountered some significant challenges.

### SUMMARY OF THE DISCLOSURE

In one aspect, a hydrogen generator is provided which comprises (a) a chamber having a hydrogen-containing material disposed therein; (b) a first fluidic pathway which includes said chamber, said first fluidic pathway further including an upstream portion which is upstream of said chamber, and a downstream portion which is downstream from said chamber; and (c) a second fluidic pathway which does not include said chamber, and which is adjoined to said downstream portion of said first fluidic pathway; wherein said first and second fluidic pathways contain a liquid medium in which said hydrogen-containing material is soluble.

In another aspect, a hydrogen generator is provided which comprises (a) a first reservoir containing a liquid medium; (b) a second reservoir containing a hydrogen-containing material, said second reservoir being in fluidic communication with said first reservoir by way of a first fluidic pathway; and (c) a second fluidic pathway which is in fluidic communication with said first reservoir, and which is also in fluidic communication with said first fluidic pathway at a point downstream from said second reservoir.

In a further aspect, a hydrogen generator is provided which comprises (a) a chamber having a hydrogen-containing material disposed therein; (b) a first reservoir containing a liquid medium which dissolves said hydrogen-containing material; (c) a reactor adapted to react a solution of the hydrogen-containing material in the liquid medium to generate hydrogen gas; (d) a first fluidic pathway connecting said first reservoir to said chamber; (e) a second fluidic pathway connecting said chamber to said reactor; and (f) a third fluidic pathway connecting said first reservoir to said second fluidic pathway at a point downstream from said chamber.

In yet another aspect, a method for generating hydrogen gas is provided which comprises (a) dissolving a hydrogen-containing material in a first liquid medium to produce a first solution; (b) diluting the first solution to produce a second solution; and (c) reacting the second solution in the presence of a catalyst to generate hydrogen gas.

In still another aspect, a hydrogen generator is provided which comprises a flexible envelope disposed within a pressurized chamber, said flexible envelope having a hydrogen-containing material disposed therein.

### BRIEF DESCRIPTION OF THE DRAWINGS

FIG. 1 is an illustration of a first embodiment of a hydrogen generator in accordance with the teachings herein.

FIG. 2 is an illustration of a second embodiment of a hydrogen generator in accordance with the teachings herein.

FIG. 3 is an alternative embodiment of the second reservoir which may be utilized in the hydrogen generator depicted in FIG. 2.

FIG. 4 is a cross-section taken along LINE 4-4 of FIG. 3.

### DETAILED DESCRIPTION

### A. Overview

One challenge encountered in the commercial implementation of hydrogen generators is that the passages of the hydrogen generator frequently become clogged over time, thus interfering with the operation of the device. This problem is exacerbated in miniaturized hydrogen generators of the type commonly required for use in laptop computers and other consumer devices, due to the smaller diameters of the flow paths typically utilized in these devices.

After careful study, the current investigators have linked this problem to changes in the solubility of sodium borohydride and other hydrogen-containing materials in solution. In particular, a typical hydrogen generator based on sodium borohydride utilizes a liquid medium, such as an aqueous sodium hydroxide solution, to dissolve a portion of sodium borohydride. The resulting solution may then be reacted in the presence of a catalyst to generate hydrogen gas. However, hydrogen generators of this type typically operate by flowing a portion of the liquid medium over one or more pellets of sodium borohydride. Since sodium borohydride dissolves readily in aqueous sodium hydroxide solutions, this approach typically has the result of creating a saturated solution of sodium borohydride. Consequently, if any of the various parameters (such as, for example, temperature) which control the solubility of sodium borohydride in the aqueous solution change after the sodium borohydride has been solubilized, precipitates of sodium borohydride may form from the solution. These precipitates may clog the channels of the device.

It has now been found that this problem may be overcome through the provision in a hydrogen generator of a dilution scheme which dilutes the solution of hydrogen-containing material shortly after it is formed. This may be accomplished, for example, by combining the solution with an additional portion of solvent. Because the resulting solution is no longer saturated, the formation of precipitates may be reduced or eliminated.

A further challenge encountered in the commercial implementation of hydrogen generators relates to the dissolution of the hydrogen-containing material. In some previous designs, as in the hydrogen generators described in U.S. 2008/0014481 (Fiebig), the hydrogen-containing material is present as a sodium borohydride pellet. A spring is utilized to press one end of the pellet against a flow diffuser, and a liquid medium is flowed across the flow diffuser to dissolve the pellet. The spring is intended to ensure that the pellet advances along its longitudinal axis and towards the flow diffuser as the pellet dissolves.

While the foregoing approach is useful in many applications, in some applications, the pellet is observed to dissolve in an uneven manner. As a result, “islands” of undissolved material may form on the face of the pellet, thus preventing the pellet from advancing. The formation of such islands may cause variations in the amount of hydrogen-containing material dissolved in the liquid medium. This, in turn, may introduce variations and inefficiencies into the performance of the hydrogen generator.

It has now been found that this problem may be overcome through the provision of a casing or envelope over the hydrogen-containing material. In a preferred embodiment, the hydrogen-containing material is present as a pellet, and the envelope is an elastomeric tube which is stretched over the pellet. The liquid medium may then be flowed from one end of the tube to the other such that it flows between the pellet and the inner diameter of the tube. The flow path in such an embodiment is typically longer than the flow path in devices of the type noted above, which thus reduces or eliminates variations in the concentration of hydrogen containing material in the liquid medium by ensuring that the resulting solution is always saturated.

Moreover, the elastomeric tube tends to conform to the shape of the pellet as it dissolves, thereby keeping the liquid medium near the surface of the pellet. This minimizes liquid volume when the hydrogen generator is shut down, and also minimizes the overall volume required within the hydrogen generator to accommodate the hydrogen-containing material. Furthermore, if any concave channels or features form on the pellet as it dissolves, the stretched elastomer of the tube can span such channels or features, thereby creating a cavity in which the liquid medium can flow near the surface of the tube rather than near of the surface of the pellet.

In some embodiments, the performance of the elastomeric tube (or other conformable envelope having a hydrogen-containing material disposed therein) may be further enhanced by placing the envelope within a pressurized chamber such that the envelope is pressed tightly against the pellet. The use of a pressurized chamber enhances the flow path and conformability of the envelope by conforming it to even concave pellet surfaces that may form during operation, such that any degradation in dissolution performance over the lifetime of the pellet may be significantly reduced. Moreover, a compressed envelope of this type can be used with pellets of a hydrogen-containing material which have a wide variety of form factors, thus adding significant flexibility to the design of the hydrogen generator.

The foregoing improvements, and the devices which may be utilized to implement them, may be further understood with respect to the specific, non-limiting embodiments described below.

### B. First Embodiment

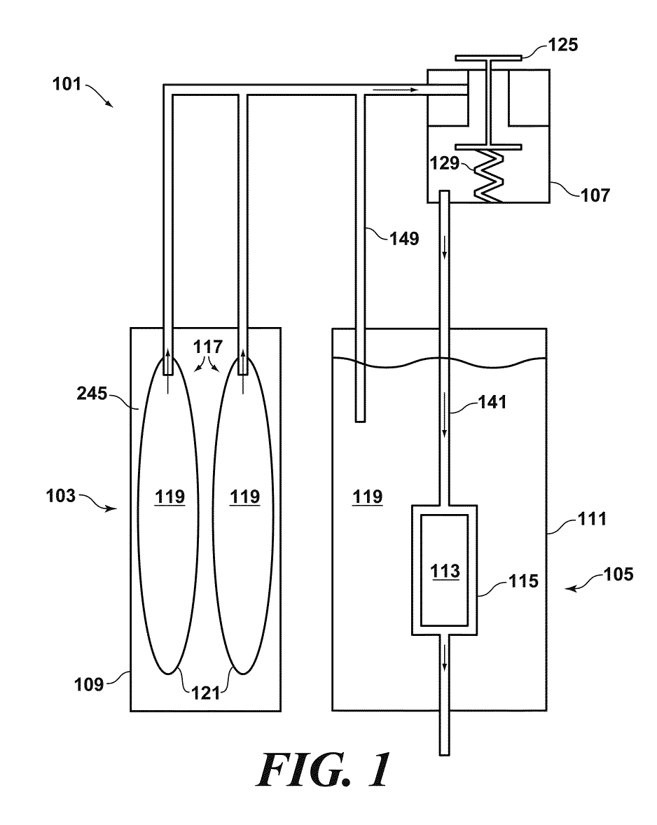

FIG. 1 depicts a first particular, non-limiting embodiment of a hydrogen generator made in accordance with the teachings herein. The hydrogen generator 101 depicted therein comprises a first reservoir 103 which is in fluidic communication with a second reservoir 105 via a regulator 107. Preferably, the first 103 and second 105 reservoirs are equipped, respectively, with first 109 and second 111 rigid housings, and the pressure inside of sub-reservoirs 117 and second housing 111 is the same or is similar.

The second reservoir 105 contains a hydrogen-containing material 113. Preferably, the hydrogen-containing material 113 is disposed within a casing 115. The casing 115 preferably comprises an elastomeric material which can conform to the shape of the hydrogen-containing material 113 such that, as the hydrogen-containing material is consumed and shrinks in volume, the casing shrinks correspondingly. In the particular embodiment depicted, the hydrogen-containing material 113 is in the form of a cylindrical pellet, and the casing 115 comprises an elastomeric material disposed about the surface of the pellet in pressing engagement thereto.

The first reservoir 103 preferably contains one or more sub-reservoirs 117. Each of the sub-reservoirs 117 contains a liquid medium 119 which is capable of dissolving the hydrogen-containing material 113. The sub-reservoirs 117 are preferably bounded, either individually or collectively, by an elastomeric material 121.

The regulator 107 is adapted to control the flow of fluid between the first reservoir 103 (and more particularly, the sub-reservoirs 117 thereof) and the second reservoir 105. In the particular embodiment depicted, the regulator is equipped with an actuator 125 which moves the regulator 107 between a closed position in which the flow of fluid from the first reservoir 103 to the second reservoir 105 is prevented, and an open position in which the flow of fluid from the first reservoir 103 to the second reservoir 105 is allowed. The regulator 107 in this particular embodiment is mechanically activated through the application of external pressure to the actuator 125. The actuator is equipped with an opposing spring 129 which acts to maintain the actuator 125 in a closed position when no external pressure is being applied thereto.

A positive pressure is applied to the fluid 119 by virtue of the flexible material 121, so that, when the regulator 107 is placed in an open position, the flow of fluid from the sub-reservoirs 117 to the casing 115 is enabled. Advantageously, the flexible material 121 can be readily adapted to provide an essentially constant pressure on the fluid medium 119 contained therein such that this pressure is essentially independent of the volume of the sub-reservoirs 117. Consequently, this pressure remains essentially constant during the operating lifetime of the device.

### C. Second Embodiment

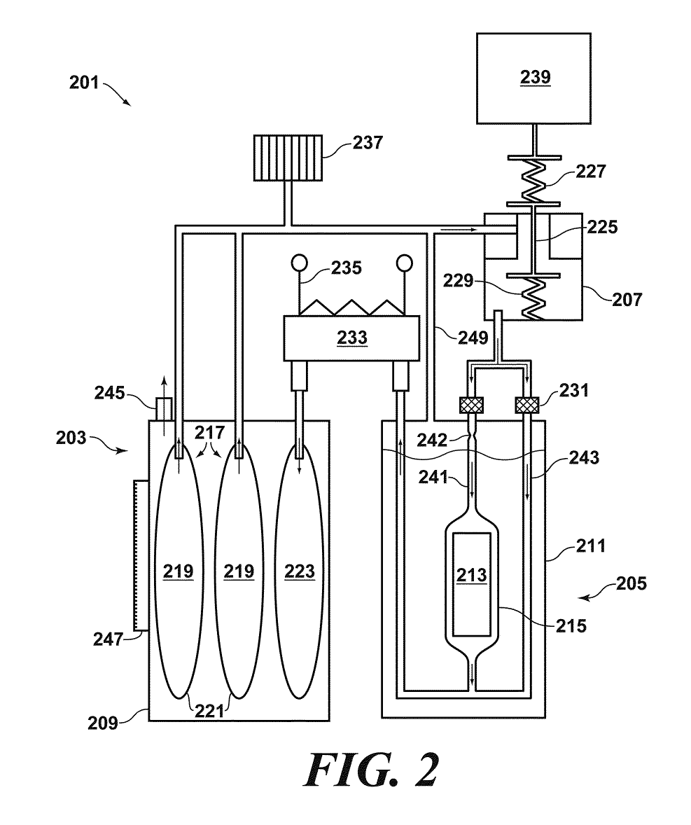

FIG. 2 depicts a second particular, non-limiting embodiment of a hydrogen generator made in accordance with the teachings herein. The particular hydrogen generator 201 depicted therein comprises a first reservoir 203 which is in fluidic communication with a second reservoir 205 via a regulator 207. Preferably, the first 203 and second 205 reservoirs are equipped, respectively, with first 209 and second 211 rigid housings, and the pressure inside of sub-reservoirs 217 and second housing 211 is the same or is similar.

The second reservoir 205 is charged with a hydrogen-containing material 213. Preferably, the hydrogen-containing material 213 is disposed within a casing 215. The casing 215 preferably comprises a flexible material which may be, for example, an elastomeric material, and which can conform to the shape of the hydrogen-containing material 213 such that, as the hydrogen-containing material is consumed and reduces in volume, the casing changes in volume correspondingly. In the particular embodiment depicted, the hydrogen-containing material 213 is in the form of a cylindrical pellet, and the casing 215 comprises an elastomeric material disposed about the surface of the pellet in pressing engagement thereto.

The first reservoir 203 preferably contains one or more sub-reservoirs 217. Each of the sub-reservoirs 217 contains a liquid medium 219 which is capable of dissolving the hydrogen-containing material 213. The sub-reservoirs 217 are preferably bounded, either individually or collectively, by an elastomeric material 221. In the particular embodiment depicted, a byproduct receptacle 223 is also disposed within the first reservoir 203.

The regulator 207 is adapted to control the flow of fluid between the first reservoir 203 (and more particularly, the sub-reservoirs 217 thereof) and the second reservoir 205 (and more particularly, casing 215 contained therein). In the particular embodiment depicted, the regulator 207 is equipped with an actuator 225 which moves the regulator 207 between a closed position in which the flow of fluid from the first reservoir 203 to the second reservoir 205 is prevented, and an open position in which the flow of fluid from the first reservoir 203 to the second reservoir 205 is allowed. The regulator 207 in this particular embodiment is equipped with first 227 and second 229 balanced springs such that the regulator 207 will adapt a closed position if hydrogen pressure builds up to a certain level on the exit side of the regulator 207. Thus, the first 227 and second 229 balanced springs serve to reduce or terminate the flow of reactants in the event that the demand for hydrogen gas has abated or ceased.

The hydrogen generator 201 is also equipped with a pair of filters 231 downstream from the actuator which remove particulate materials from the fluid flow. These filters 231 may comprise a glass frit, a porous mesh, or other suitable materials. In some embodiments, filters may be provided downstream from the hydrogen-containing materials, either in addition to, or in lieu of, filters 231.

The hydrogen generator 201 is further equipped with a reactor 233 where the reactants (typically a solution or slurry of the hydrogen-containing material 213 in the liquid medium 219) are reacted, preferably in the presence of a catalyst, to generate hydrogen gas. The reactor 233 may be provided with a resistive heating coil 235 or other heating means or thermal controls to achieve optimal reaction conditions. Thus, for example, the resistive heating coil 235 may provide electrical heating of the reactor for rapid start-up.

The hydrogen generator 201 is also equipped with a vent 247 for venting hydrogen gas if the pressure within the first reservoir 203 exceeds a predetermined level. This predetermined level may vary from one application to another, but in a typical application will be within the range of about 20 psi to about 30 psi. Preferably, the vent 247 is equipped with Pt or another suitable catalyst which is adapted to convert hydrogen gas into water in the presence of air. The vent 247 is adapted to mix any hydrogen gas flowing through it with oxygen (preferably in the form of ambient air) in the presence of the catalyst to generate water. The water so generated, which will typically be in vapor form, is then preferably vented to the external environment. In addition to maintaining the first reservoir 203 within a desired pressure range, the vent 247 also prevents the emission of hydrogen gas from the device. Such emissions have been identified as a source of fires or explosions in some prior art hydrogen generators.

Prior to use, the hydrogen generator 201 is charged with the liquid medium 219 by way of a septum 237. Typically, this will be achieved by placing the regulator 207 in a closed condition, and pumping the liquid medium 219 into the system by way of the septum 237 until the sub-reservoirs 217 are inflated by a proper amount. When the hydrogen-containing material is sodium borohydride, the liquid medium is preferably an alkaline solution, is more preferably a sodium hydroxide solution, and is most preferably a 0.5% sodium hydroxide solution.

During use, the regulator 207 is placed into an open position. This may be accomplished either manually or electronically. In some embodiments, an external device 239 may be mated to the regulator 207, and may be adapted to control the generation of hydrogen gas by manipulating the actuator 225. A positive pressure is applied to the fluid 219 by virtue of the elastomeric material 221, so that, when the regulator 207 is placed in an open position, the flow of fluid from the sub-reservoirs 217 to the casing 215 is enabled. Advantageously, the elastomeric material 221 can be readily adapted to provide an essentially constant pressure on the fluid medium 219 contained therein such that this pressure is essentially independent of the volume of the sub-reservoirs 217. Consequently, this pressure remains essentially constant during the operating lifetime of the device.

In the particular embodiment depicted, as the liquid medium 219 exits the regulator 207, it is divided into first and second liquid streams by way of first 241 and second 243 branches. Each of the first and second liquid streams flows through a filter 231, where any particulate materials in the streams are removed. Although each of the branches 241 and 243 are depicted as being equipped with a separate filter 231, one skilled in the art will appreciate that a single filter could be utilized instead at a location upstream of the point at which the branches diverge.

The first liquid stream flows into the casing 215 by way of a first branch 241, and the second liquid stream is routed around the casing through a second branch 243. The first 241 and second 243 branches intersect downstream of the casing 215, thus mixing the first liquid stream (which now contains a fuel mixture consisting of a portion of hydrogen-containing material dissolved in the liquid medium) with the second liquid stream. This has the effect of diluting the fuel mixture initially formed in the first branch, thus reducing or eliminating the formation of precipitates from the solution.

In some embodiments, the first branch 241 and/or the second branch 243 may contain a restriction 242 or other suitable means for increasing flow resistance. Such means may comprise, for example, screens, a porous frit or medium, a needle valve, a capillary tube, a tortuous path, or merely an indentation or narrowing of the branch as depicted in FIG. 2.

### C. Variation on Second Embodiment

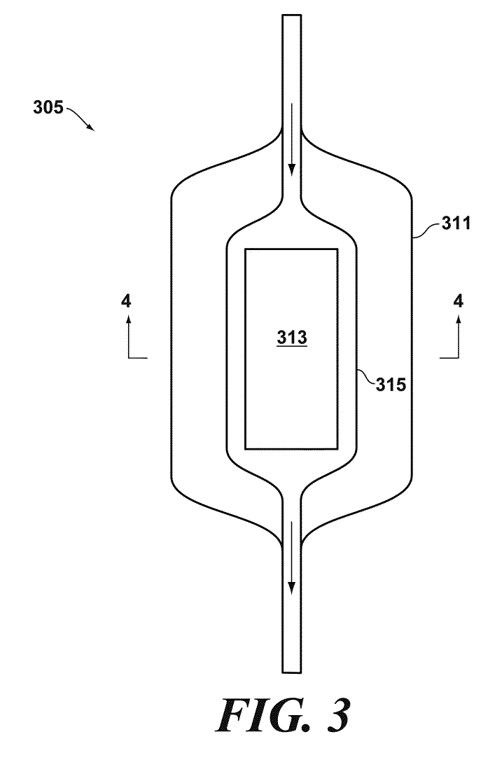

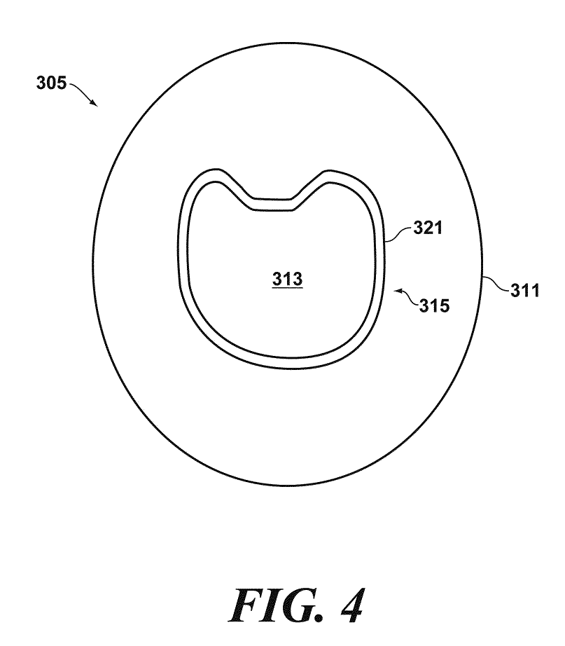

FIGS. 3-4 depict a further possible variation of the second reservoir 205 of FIG. 2. Unlike the embodiment of FIG. 2 in which the second reservoir 205 is preferably equipped with a rigid housing 211, the second reservoir 305 depicted in FIGS. 3-4 is equipped with an elastomeric housing 311. Such an embodiment is advantageous in that the elastomeric housing 311 applies essentially uniform pressure to the casing 315, irrespective of its geometry or volume, and without having to be pressurized. Hence, the pressure applied by the elastomeric housing 311 remains essentially uniform even as the volume of the casing 315 decreases due to consumption of the hydrogen-containing material disposed therein. The remaining elements in this embodiment are similar to their like numbered counterparts in FIG. 2.

### D. Elastomeric Materials

Various flexible and/or elastomeric materials may be utilized in the construction of the housing 311, casing 315, the elastomeric material 221, and the other elastomeric articles and components utilized in the hydrogen generators described herein. Possible materials include various polymers or rubbers such as, but not limited to, natural rubbers; polyisoprenes; butyl rubbers (copolymers of isoprene and isobutylene); polybutadienes; styrene-butadienes; nitrile rubbers, including hydrogenated nitrile rubbers; chloroprene rubbers; EPM (ethylene propylene rubbers, copolymers of ethylene and propylene) and EPDM rubbers (ethylene propylene diene rubbers, terpolymers of ethylene, propylene and a diene component); epichlorohydrin rubbers (ECO); polyacrylic rubbers (ACM, ABR); silicone rubbers (SI, Q, VMQ); fluorosilicone rubbers (FVMQ); fluoroelastomers (FKM and FEPM); perfluoroelastomers (FFKM); polyether block amides (PEBA); chlorosulfonated polyethylenes (CSM); ethylene-vinyl acetates (EVA); thermoplastic elastomers (TPE); thermoplastic vulcanizates (TPV); thermoplastic polyurethanes (TPU); thermoplastic olefins (TPO); elastomeric proteins, such as, for example, resilin and elastin; and polysulfide rubbers. In some embodiments, elastomeric bands, fibers, or articles comprising any of the foregoing materials may be used in conjunction with other compressible or conformable materials to produce an elastomeric article.

### E. Catalytic Reactor

1. Design

The catalytic reactor which is utilized in the hydrogen generators disclosed herein is preferably configured as a low volume, high surface area reactor which accelerates the flow of the reaction products into the reacted solution receptacle, and whose length may be selected to maximize residence time of the mixture in the reactor, thereby ensuring maximum transfer of the heat of reaction to the reactor. Hence, the reactor preferably comprises a microfluidic flow channel which may be etched, carved, molded, or machined into a substrate. U.S. 60/967,035 (Withers-Kirby et al.), entitled “Hydrogen Generator With Low Volume High Surface Area Reactor”, which was filed on Aug. 30, 2007, and which is incorporated by reference herein in its entirety, discloses particular, non-limiting embodiments of such reactors which may be utilized in the devices described herein. In some embodiments, this flow channel may be defined using masking and etching processes known to the semiconductor arts. After the flow channel is formed, a suitable catalyst may be applied to the surfaces of the flow channel. Preferably, this catalyst is applied along the entire length of the flow channel.

2. Reactor Substrate Materials

Reactors for use in the devices and methodologies described herein may be made from various materials. These materials may be thermally conductive or thermally insulating.

One class of particularly preferably thermally conductive materials which may be used in the fabrication of the reactor includes ceramics and, in particular, high surface area, porous ceramics. Such materials include, but are not limited to, ceramics based on nitrides, carbides, and various mixtures of the two, such as ceramics comprising boron nitride (BN), aluminum nitride (AlN), aluminum silicon carbide (AlSiC), or various mixtures of the foregoing. Other thermally conductive materials which may be used in the fabrication of the reactor include graphite, graphite composites, and various metals or metal alloys.

Various thermally insulating materials may also be used in the construction of the reactor. This class of materials also includes various high surface area, porous ceramics, including those comprising zirconia, alumina (Al₂O₃), and various mixtures of the foregoing.

3. Reactor Heating Elements and Methods

a. Active Heating

In the various catalytic reactors disclosed herein, it is preferred to heat the liquid reactant in the presence of the catalyst (or to heat the catalytic surface or reactor itself) since, at least when sodium borohydride is used as the hydrogen-containing material, the hydrogen generation reaction is typically catalyzed with greater efficiency at higher temperature levels. Moreover, the distribution of byproducts at higher temperatures (e.g., around 90° C.) will typically be centered around lower hydration states than is the case when the hydrogen generation reaction occurs at lower temperatures. It will be appreciated that, in various embodiments, suitable heating may be implemented by heating the fluid, heating the catalyst, and/or heating the reactor. In some embodiments, heating may also be utilized as a solubility enhancer for the hydrogen-containing material.

In one possible embodiment, a resistive wire or other heating element (element 235 in the particular reactor depicted in FIG. 2) is incorporated into or around the flow channel of the reactor. This heating element may comprise Nichrome (a nickel chromium alloy), tungsten, or another suitable material with sufficient resistivity to generate heat when a voltage is applied across it. A voltage is then applied to the heating element when the device is turned on (or at suitable intervals during the operation of the device), which heats the heating element and the surrounding surfaces or fluid to promote fast start-up times for the reactor.

In another possible embodiment, the reactor comprises a composite structure which includes an insulating base material (such as a plastic) which is coated with an electrically conductive, high resistance material such as chrome. The high resistance material is then coated with a layer of an electrically insulating material and a layer of catalyst. In such an embodiment, heating may be supplied on demand by applying a voltage across the electrically conductive layer.

In some embodiments, the reactor may contain a channel which may be machined, etched, carved, or molded into the surface of a heating element, such as a PTC (positive thermal coefficient) thermistor. Such a thermistor may comprise, for example, barium titanate. In some embodiments, the catalyst may be applied directly to the heating element, while in other embodiments, an electrically insulating material may be deposited on the heating element, followed by deposition of the catalyst.

In the case of hydrogen generators that are to be used in conjunction with fuel cells in laptop computers or handheld electronic devices, the dimensions of the catalytic reactor will frequently be sufficiently small such that flash heating of the liquid reactant can be economically performed in the presence of the catalyst, using techniques similar to those developed for thermal inkjet printers. Such flash heating may be utilized to generate discrete bubbles of hydrogen gas that span the diameter of the fluid channel through the reactor, and that may be readily adsorbed from the fluid flow in the reactor through a hydrogen-permeable membrane. Hence, flash heating can serve the simultaneous purposes of improving the efficiency of the hydrogen generation reaction, reducing the amount of water consumed by reaction byproducts, and facilitating the separation of hydrogen gas from reaction byproducts and unreacted materials. Moreover, the generation of bubbles via flash heating may be used in the devices and methodologies described herein, either alone or in combination with other such mechanisms as piezoelectric actuators, to push (or pull) liquid reactants or other materials through the reaction zone and through other parts of the device.

In one such embodiment, the catalytic reactor may be fabricated with a series of tiny, electrically-heated chambers that may be constructed, for example, through photolithography. In use, the reactor runs a pulse of current through the heating elements, which rapidly heats the liquid reactant in the vicinity of the catalyst. This results in the formation of a bubble of hydrogen which, as it is adsorbed through an adjacent hydrogen-permeable membrane, sucks a further portion of liquid reactant into the catalytic reactor. Hence, the flash heater acts as an effective pumping mechanism while hydrogen is being generated, and further provides a convenient means by which the rate of hydrogen evolution may be scaled up or down in accordance with demand.

It will be appreciated that the flash heating methods described above may be implemented in a variety of ways. For example, a positive temperature coefficient thermistor may be provided which is integrated with, or which controls, the heating devices. Such a thermistor may be designed with an electrical resistance that is low at room temperature, but which becomes very high at some desired strike temperature. Hence, the thermistor will efficiently heat the liquid reactants up to the strike temperature, and will then effectively shut off.

In some embodiments, electronic circuitry controlling the catalytic reactor may be incorporated into the hydrogen generator. In other embodiments, some, or the bulk of, this circuitry may be integrated into a hydrogen fuel cell that is coupled to the hydrogen generator, or into the host device. This latter type of embodiment may be particularly advantageous in applications where it is desired to fashion the hydrogen generator as a disposable device. The electronic circuitry may also comprise various piezoelectric pumps which may be used to control the flow of reactants through the hydrogen generator.

The electronic circuitry may further include sensors which are adapted, for example, to sense changes in the volume of components of the hydrogen generator due, for example, to the accumulation of hydrogen gas. It will be appreciated that such circuitry may be utilized to monitor the status of the hydrogen generator, and/or to control the hydrogen evolution reaction in accordance with the existing demand for hydrogen.

b. Passive Heating

The reactor, solution, and/or catalyst may also be heated passively in various embodiments in accordance with the teachings herein. Such passive heating is advantageous in that it does not require an external power supply.

In some embodiments, hydrogen combustion may be used to produce heat inside of the reactor. Such embodiments may be utilized, for example, in devices where the hydrogen generator is being used in combination with, or is integrated with, a hydrogen fuel cell. In these embodiments, hydrogen gas reacts with oxygen in the presence of a catalyst (such as Pt) to generate heat. The heat may then be utilized to heat the reactor, fluid and/or catalyst. In some embodiments, hydrogen combustion may be made to occur inside the reactor during generation of the hydrogen gas by introducing oxygen or air into the feed stream entering the reactor.

In some embodiments, hydrogen combustion may also be used to produce heat outside of the reactor. In such embodiments, a surface coated with a suitable catalyst (such as, for example, Pt) may be mounted or positioned outside of the reactor where it is exposed to air, but is still in thermal contact with the reactor body. A portion of hydrogen gas may then be flowed over the surface such that the resulting combustion will heat the reactor.

In other embodiments, various chemical additives may be added to the hydrogen-containing material such that, when water or another fluid medium contacts the hydrogen-containing material, it dissolves a portion of the chemical additive via an exothermic process. The heat released by this process thus heats the resulting solution. Examples of chemical additives which may be used for this process include, but are not limited to, calcium oxide (CaO). The heat released by such an additive may be useful not only in heating the solution before it enters the reactor, but also in increasing the solubility of the hydrogen-containing material in the liquid medium.

4. Reactor Insulation Materials

For reasons noted above, it is preferable to run the catalytic reactor at elevated temperatures. Accordingly, the reactors employed in the devices and methodologies described herein are preferably thermally insulated to retain the heat generated by the exothermic hydrogen generation reaction. Various materials may be used for this purpose. These materials include, for example, various aerogels, such as those based on silica; various foams, such as syntactic (glass) foams and aerated or cellular plastics or polymeric materials; and various ceramics. In some embodiments, a gap, which may be subject to a vacuum or filled with air or a gas, may be provided around the reactor for a similar purpose.

### F. Byproduct Receptacle

Various bags and other receptacles or containers may be used to receive the reaction products and byproducts in the hydrogen generators described herein. Preferably, at least a portion of these receptacles comprise a material which is both gas permeable and liquid impermeable. More preferably, at least a portion of these receptacles comprises a material, such as porous or expanded polytetrafluoroethylene (PTFE), which is both gas permeable and hydrophobic.

The reacted solution receptacle may be fabricated through a number of different processes. For example, if the receptacle comprises PTFE, it may be constructed through thermal sealing or welding of multiple layers of porous or expanded PTFE (ePTFE). This may be accomplished, for example, by pressing multiple layers of ePTFE against a rubber backing using a heated or ultrasonic hot tool or die, or by pressing multiple layers of ePTFE between the heated or ultrasonic surfaces of a tool or die.

The reacted solution receptacle may be attached to the reaction product inlet in various ways. For example, the receptacle may be a bag which is made partially or wholly from ePTFE. Such a bag may be attached to a tube or other suitable receptacle inlet through welding or thermal sealing by using a hot or ultrasonic tool pressed against a portion of the bag which has been placed on or around the receptacle inlet. The receptacle inlet may then be mechanically coupled with the reaction product inlet using various suitable techniques as are known to the art.

For example, the receptacle inlet and the reaction product inlet may have complimentary threaded surfaces that can be rotatingly engaged to achieve a tight seal between the two, or the two inlets may be press fitted together. In other embodiments, one or both of these inlets may have a protrusion or other surface feature which releasably engages a surface or feature on the other inlet to maintain the two inlets in a coupled relationship. In still other embodiments, the receptacle may be mechanically attached to the upper housing element or to the reaction product inlet thereof via a press-in ferrule. In further other possible embodiments, the receptacle may be a bag which is attached by bonding or through the use of an adhesive to the upper housing element, and in addition or in the alternative, the receptacle inlet may be attached to the reaction product inlet by bonding or through the use of an adhesive.

In some embodiments, the connection between the reaction product inlet and the receptacle may be adapted to allow easy release of solidified materials that might otherwise block the flow of reacted solution into the receptacle. This may be accomplished, for example, by tapering the inner diameter of any such connector such that the inner diameter increases as one proceeds along the axis of the connector in the direction of the receptacle. Some embodiments may also utilize a heated tube or wire, or a tube or wire which conducts heat from the reactor or another heat source.

In other embodiments, such blockages may be avoided or mitigated by providing a crystal growth promoter on a portion of the interior surface of the receptacle spaced apart from the entrance into the receptacle. Such crystal growth promoters may be chemical or mechanical in nature. For example, the crystal growth promoter may comprise seed crystals which are located in a portion of the interior of the receptacle. The crystal growth promoter may also comprise a roughened surface which is more conducive to crystal growth than the surrounding surfaces. Such a surface may be achieved through mechanical abrasion or by chemical etching, or by use of an inherently porous medium.

In some embodiments of the devices disclosed herein, either or both of the external surface of the reacted solution receptacle and the interior surface of the byproducts reservoir may be provided with textured surfaces. Such surfaces prevent blockage of hydrogen permeation through the walls of the reacted solution receptacle as might occur if these two surfaces were smooth and pressed against each other. Such texturing may, for example, include a roughened surface, an open mesh, an open-celled matrix, a series of grooves or protrusions, or other such features suitable for keeping the two surfaces spaced apart from each other and/or for providing pathways for the egress of hydrogen gas.

In some embodiments, the reacted solution receptacle may be treated, coated or provided with a cobalt salt or other suitable catalytic material to induce the reaction of any unreacted borohydride or other hydrogen containing material. In some variations of this embodiment, a suitable means may be provided for capturing any hydrogen gas so generated and storing it or rerouting it so that it can be added to the hydrogen stream exiting the hydrogen generator. In other variations of this embodiment, a second catalyst may be provided to convert any hydrogen so generated into water. This may be accomplished, for example, by providing such a catalyst in the reacted solution receptacle, or by routing the hydrogen to the vent cover where it may react with the catalyst disposed therein.

### G. Fluid Reservoir

In some embodiments of the devices disclosed herein, the fluid or liquid medium used to create the solution of hydrogen-containing material may be disposed in a bag or other receptacle inside of fluid reservoir. In some embodiments of the devices disclosed herein, the surfaces of the fluid receptacle may be provided with one or more textured portions or meshes to prevent collapse of the receptacle over the fluid outlet prior to complete evacuation of the fluid receptacle. Preferably, this surface texturing is provided in the vicinity of the fluid outlet.

In other embodiments, a similar end may be achieved by vacuum forming the receptacle, either before or after it is placed in the fluid reservoir. Such vacuum forming may include one or more thermal cycles. Alternatively, a similar effect may be achieved by heat stamping, or through the use of other such methods as are known to the art.

In still other embodiments, the possibility of collapse of the receptacle around or over the fluid outlet may be reduced or eliminated through strategic location of the fluid outlet within the fluid reservoir. This may be accomplished, for example, by disposing the fluid outlet along a corner or edge of the fluid reservoir.

In some embodiments, it may be desirable to design the receptacle so as to avoid or minimize the accumulation of gases therein and/or the incidence of bubble formation. Since hydrogen gas may accumulate within the reservoir by diffusing through the walls of the receptacle, in some embodiments, the receptacle may be metallized with aluminum or other suitable metals to prevent this from happening. In variations of this embodiment, other materials which have low permeability to hydrogen may be substituted for such metallization. In some embodiments, the fluid may also be degassed prior to or after being placed in the receptacle to remove, or reduce the concentration of, any gasses dissolved therein.

In some embodiments, the fluid within the fluid receptacle may be provided with a suitable (preferably water soluble) catalyst, such as, for example, a cobalt salt, which will cause the hydrogen containing material to react with the fluid. The catalyst, or the chemistry of the solution, may be selected so that this reaction occurs at a desired rate (e.g., slowly). This approach may be particularly useful where it is desirable to react any unreacted hydrogen containing material which may be passed to the reacted solution receptacle, since the solution receptacle will then contain a portion of the catalyst.

### H. Fluid Movers

Various pumps or other such active components may be used to move fluid through the hydrogen generators and components thereof which are described herein. These include, for example, osmotic pumps, hydrogen pumps, piezoelectric pumps, bubble jets, and electrochemical pumps.

Electrochemical pumps may be especially suitable for applications in which the device will require a long shelf life. Such pumps utilize the electrolysis of a small amount of fluid (e.g., water) to generate hydrogen for the pump, and an oxygen getter to absorb the oxygen generated by the electrolysis reaction (thereby preventing it from recombining with the hydrogen). The hydrogen so generated initializes the hydrogen pump working fluid.

Various electrolyzer/bubble jet hybrids may also be used in the devices described herein. In such embodiments, the electrolyzer may be utilized as a heat source, which may reduce or avoid the need for a separate heating element to heat the reactor, catalyst or fluid.

Various passive devices may also be used to move fluid through the hydrogen generators and components thereof which are described herein. Thus, in some embodiments, various types of spring driven piston-type pumps may be utilized at various points in the flow path. In other embodiments, elastomeric receptacles may be used to contain the fluid which dissolves the hydrogen-containing material, and which undergo self-deflation to maintain the fluid under pressure. In some variations of this embodiment, one or more springs or elastic bands may be applied to the exterior of a bag or other receptacle to achieve a similar effect.

In other embodiments, pressure may be applied to the fluid receptacle by way of one or more spring driven plates. Thus, in one such embodiment, the receptacle may be in the form of a plastic bag which is maintained between one or more plates and/or another surface, and the plates or surfaces may be pressed or pulled together by means of one or more flat-leafed springs, elastomeric bands, or other such devices.

In still other embodiments, the pressure within the fluid reservoir may be manipulated to apply compressive force to the fluid receptacle. This may be accomplished, for example, by maintaining the fluid reservoir at a positive pressure, as through the addition of a suitable gas or volatile liquid. Such gasses or volatile liquids include, without limitation, butane, propane, and various halogenated hydrocarbons (including fluorocarbons, chlorofluorocarbons, and halogenated ethers). In variations of this embodiment, the gas or volatile liquid may instead be utilized to drive a piston which exerts compressive force against the fluid receptacle.

In further embodiments, a partial vacuum may be formed in or about the reacted solution receptacle to pull fluid from the fluid receptacle and through the reactor. This may be accomplished, for example, through the use of one or more extension springs.

### I. Housing Materials

Various materials may be used in the housings of the hydrogen generators described herein. Preferably, the housing comprises aluminum, due to the unique combination of strength, light weight, and relative chemical inertness. However, it will be appreciated that the housing could also be constructed from various other materials, including various metals (such as magnesium, tin, titanium, and their alloys) and various metal alloys, including steel. The housing may also comprise various polymeric materials, including polyethylene, polypropylene, PVC, nylon, graphite, and various glasses. If the housing comprises a metal such as aluminum, the interior of the housing is preferably coated with a protective layer of a suitable material, such as an epoxy resin, which is inert to the reactants and the products and byproducts of the hydrolysis reaction. The housing, or portions thereof, may also be thermally insulated.

### J. Hydrides, Borohydrides and Boranes

Various hydrides, or combinations of hydrides, that produce hydrogen upon contacting water at temperatures that are desired within the hydrogen generator may be used in the devices and methodologies described herein. Salt-like and covalent hydrides of light metals, especially those metals found in Groups I and II, and even some metals found in Group III, of the Periodic Table are useful and include, for example, hydrides of lithium, sodium, potassium, rubidium, cesium, magnesium, beryllium, calcium, aluminum or combinations thereof. Preferred hydrides include, for example, borohydrides, alanates, or combinations thereof.

As shown in TABLE 1 and TABLE 2 below, the hydrides of many of the light metals appearing in the first, second and third groups of the periodic table contain a significant amount of hydrogen on a weight percent basis and release their hydrogen by a hydrolysis reaction upon the addition of water. The hydrolysis reactions that proceed to an oxide and hydrogen (see TABLE 2) provide the highest hydrogen yield, but may not be useful for generating hydrogen in a lightweight hydrogen generator that operates at ambient conditions because these reactions tend to proceed only at high temperatures. Therefore, the most useful reactions for a lightweight hydrogen generator that operates at ambient conditions are those reactions that proceed to hydrogen and a hydroxide. Both the salt-like hydrides and the covalent hydrides are useful compounds for hydrogen production because both proceed to yield the hydroxide and hydrogen.

TABLE 1
Hydrogen Content of Metal Hydrides

| | Wt % H₂ | | |
|---|---|---|---|
| | | With | Double |
| Compound | Neat | Stoichiometric H₂O | Stoichiometric H₂O |
| Salt-like Hydrides | | | |
| LiH | 12.68 | 11.89 | 7.76 |
| NaH | 4.20 | 6.11 | 4.80 |
| KH | 2.51 | 4.10 | 3.47 |
| RbH | 1.17 | 2.11 | 1.93 |
| CsH | 0.75 | 1.41 | 1.33 |
| MgH₂ | 7.66 | 9.09 | 6.47 |
| CaH₂ | 4.79 | 6.71 | 5.16 |
| Covalent Hydrides | | | |
| LiBH₄ | 18.51 | 13.95 | 8.59 |
| NaBH₄ | 10.66 | 10.92 | 7.34 |
| KBH₄ | 7.47 | 8.96 | 6.40 |
| Mg(BH₄)₂ | 11.94 | 12.79 | 8.14 |
| Ca(BH₄)₂ | 11.56 | 11.37 | 7.54 |
| LiAlH₄ | 10.62 | 10.90 | 7.33 |
| NaAlH₄ | 7.47 | 8.96 | 6.40 |
| KAlH₄ | 5.75 | 7.60 | 5.67 |
| Li₃AlH₆ | 11.23 | 11.21 | 7.47 |
| Na₃AlH₆ | 5.93 | 7.75 | 5.76 |

TABLE 2
Hydrogen Yield from the Hydrolysis of Metal Hydrides

| | | Hydrogen Yield | |
|---|---|---|---|
| Reaction | | (wt %) | |
| | Equation | Stoichiometric | Double |
| | No. | Water | Water |
| Reaction to Oxide | | | |
| LiBH₄ + 2 H₂O → LiBO₂ + 4 H₂ | 1 | 13.95 | 8.59 |
| 2 LiH + H₂O → Li₂O + 2 H₂ | 2 | 11.89 | 7.76 |
| NaBH₄ + 2 H₂O → NaBO₂ + 4 H₂ | 3 | 10.92 | 7.34 |
| LiAlH₄ + 2 H₂O → LiAlO₂ + 4 H₂ | 4 | 10.90 | 7.33 |
| Reaction to Hydroxide | | | |
| LiBH₄ + 4 H₂O → LiB(OH)₄ + | 5 | 8.59 | 4.86 |
| 4 H₂ | | | |
| LiH + H₂O → LiOH + H₂ | 6 | 7.76 | 4.58 |
| NaBH₄ + 4 H₂O → NaB(OH)₄ + | 7 | 7.34 | 4.43 |
| 4 H₂ | | | |
| LiAlH₄ + 4 H₂O → LiAl(OH)₄ + | 8 | 7.33 | 4.43 |
| 4 H₂ | | | |
| Reaction to Hydrate Complex | | | |
| LiH + 2 H₂O → LiOH•H₂O + H₂ | 9 | 4.58 | 2.52 |
| 2 LiAlH₄ + 10 H₂O → | 10 | 6.30 | 3.70 |
| LiAl₂(OH)₇•H₂O + | | | |
| LiOH•H₂O + 8 H₂ | | | |
| NaBH₄ + 6 H₂O → | 11 | 5.49 | 3.15 |
| NaBO₂•4 H₂O + 4 H₂ | | | |

The salt-like hydrides, such as LiH, NaH, and MgH₂, are generally not soluble in most common solvents under near ambient conditions. Many of these compounds are only stable as solids, and decompose when heated, rather than melting congruently. These compounds tend to react spontaneously with water to produce hydrogen, and continue to react as long as there is contact between the water and the salt-like hydride. In some cases the reaction products may form a blocking layer that slows or stops the reaction, but breaking up or dispersing the blocking layer or removing it from the reaction zone immediately returns the reaction to its initial rate as the water can again contact the unreacted hydride. Methods for controlling the hydrogen production from the salt-like compounds generally include controlling the rate of water addition.

The covalent hydrides shown in TABLE 1 are comprised of a covalently bonded hydride anion, e.g., BH₄⁻, AlH₄⁻, and a simple cation, e.g., Na⁺, Li⁺. These compounds are frequently soluble in high dielectric solvents, although some decomposition may occur. For example, NaBH₄ promptly reacts with water at neutral or acidic pH but is kinetically quite slow at alkaline pH. When NaBH₄ is added to neutral pH water, the reaction proceeds but, because the product is alkaline, the reaction slows to a near stop as the pH of the water rises and a metastable solution is formed. In fact, a basic solution of NaBH₄ is stable for months at temperatures below 5° C.

Some of the covalent hydrides, such as LiAlH₄, react very similarly to the salt-like hydrides and react with water in a hydrolysis reaction as long as water remains in contact with the hydrides. Other covalent hydrides react similarly to NaBH₄ and KBH₄ and only react with water to a limited extent, forming metastable solutions. However, in the presence of catalysts, these metastable solutions continue to react and generate hydrogen.

Using a catalyst to drive the hydrolysis reaction of the covalent hydrides to completion is advantageous because the weight percent of hydrogen available in the covalent hydrides is generally higher than that available in the salt-like hydrides, as shown in TABLE 1. Therefore, the covalent hydrides are preferred as a hydrogen source in some embodiments of a hydrogen generator because of their higher hydrogen content as a weight percent of the total mass of the generator.

The devices and methodologies described herein may use solid chemical hydrides as the hydrogen-containing material which is combined with water in a manner that facilitates a hydrolysis reaction to generate hydrogen gas. Preferably, these chemical hydrides include alkali metal borohydrides, alkali metal hydrides, metal borohydrides, and metal hydrides, including, but not limited to, sodium borohydride NaBH₄ (sometimes designated NBH), sodium hydride (NaH), lithium borohydride (LiBH₄), lithium hydride (LiH), calcium hydride (CaH₂), calcium borohydride (Ca(BH₄)₂), magnesium borohydride (Mg(BH₄)₂), potassium borohydride (KBH₄), and aluminum borohydride (Al(BH₄)₃).

Another class of materials that may be useful in the devices and methodologies described herein are chemical hydrides with empirical formula BₓNₓH_{y} and various compounds of the general formula BₓN_{y}H_{z}. Specific examples of these materials include aminoboranes such as ammonia borane (H₃BNH₃), diborane diammoniate, H₂B(NH₃)₂BH₄, poly-(aminoborane), borazine (B₃N₃H₆), morpholine borane, borane-tetrahydrofuran complex, diborane, and the like. In some applications, hydrazine and its derivatives may also be useful, especially in applications where the toxicity of many hydrazine compounds is trumped by other considerations.

Various hydrogen gas-generating formulations may be prepared using these or other aminoboranes (or their derivatives). In some cases, the aminoboranes may be mixed and ball milled together with a reactive heat-generating compound, such as LiAlH₄, or with a mixture, such as NaBH₄ and Fe₂O₃. Upon ignition, the heat-generating compound in the mixture undergoes an exothermic reaction, and the energy released by this reaction pyrolyzes the aminoborane(s), thus forming boron nitride (BN) and H₂ gas. A heating wire, comprising nichrome or other suitable materials, may be used to initiate a self-sustaining reaction within these compositions.

In some embodiments of the devices and methodologies described herein, salt hydrates may be utilized as the water-generating material. The use of such materials can be advantageous in some applications due in part to the large amounts of thermal energy per unit weight that can be consumed by the dehydration reaction of these materials. Materials other than hydrate salts may be used in place of, or in addition to, these materials in the various devices and methodologies disclosed herein. For example, materials that undergo condensation reactions (especially dehydration condensation reactions), either by themselves or by reacting with other materials, may be used. One example of such a material includes materials that undergo condensation polymerization reactions. Another example of such a material are materials that undergo dehydration reactions, either through intramolecular or intermolecular processes. For example, carboxylic acids and polycarboxylic acids that undergo dehydration reactions to form the corresponding ester, ether, or acetate, either through an intermolecular reaction or through an intramolecular reaction, may be utilized in some embodiments as the water-generating material. A further advantage of this type of material is that the dehydration product may contain no hydration states, or fewer hydration states, than the starting material, thus increasing the total amount of water liberated by the reaction.

A further class of materials that may be used in this capacity include sterically hindered hydrates that exhibit rotational isomerism. These materials are capable of undergoing rotation about the axis of a central bond (this will frequently be a boron carbon bond, a nitrogen-nitrogen bond, or a carbon-carbon bond, but may occur around other bonds as well) to transition between at least a first and second isomeric state. The material is provided in a first state in which it is an n-hydrate material at temperature T₁. However, upon exposure to heat, it undergoes a dehydration reaction, and also undergoes rotation about the bond to transition to a second isomeric state in which it is a k-hydrate material at T₁, wherein n>k. This may be, for example, because of a change in symmetry of the second state compared to the first state, or because of the presence of hydrogen bonding or other phenomenon which interfere with the ability of water molecules to bind to the material (hydrogen bonding and other such phenomenon may also be utilized advantageously to keep the material in the second isomeric state after rotation about the axis has occurred). As a result of this reaction, the hydrate loses water irreversibly or semi-irreversibly.

A similar phenomenon may be used with the hydrogen-generating material itself. That is, the hydrogen-generating material may be designed so that, when it undergoes the hydrogen evolution reaction, the heat evolved causes the resulting byproduct to assume (preferably irreversibly) a second rotational isomeric state in which it binds to a reduced amount of water, as compared to the rotational isomers of the byproduct. The heat adsorbed by the change in isomeric states may serve as a further aid in controlling the overall heat generated by the hydrogen generator. In some embodiments, rotational isomers may be used as a heat adsorbing means, even without respect to their possible hydration states.

In some embodiments of the devices, methodologies and compositions described herein, steric hindrance can be utilized as a mechanism to prevent the hydrogen-generating material from undergoing a hydration reaction, as, for example, by occluding binding sites for water molecules in the reaction byproduct. In these embodiments, various substituted hydrides, borohydrides, boranes, aminoboranes, hydrazines, and the like may be utilized as the sterically hindered reactant, with the choice of substituents depending in part on the stereochemistry of the system. These materials offer the potential advantage of consuming most, if not all, of the water present in the system in the hydrogen-generation reaction, whether that water is present as free water molecules or water of crystallization.

Still another class of materials useful as a source of stored moisture are polymer hydrates. These compounds include (but are not limited to) polycarboxylic acids, polyacrylamides, and other polymeric materials with functional groups capable of binding to water. Both classes of compounds can act to solidify, or gel, large quantities of water. Unlike inorganic hydrates, these materials lack both a crystalline structure (i.e., they are amorphous) and a sharp melting or dehydration temperature. Both give up their water over a broad temperature range. The use of compounds such as these in a reactor of the type described above can produce a gradual release of water. In some embodiments, the rate of release may increase with any increase in temperature.

Some of these compounds, notably polyacrylimides, have another useful feature, namely, that their affinity for water tends to vary inversely with the ionic strength of the solution they are in contact with. This means that a saturated polymer in contact with a dilute ionic solution will release water into the solution as its ion concentration increases. If a solid hydride is brought into contact with a polymer saturated with respect to pure water, the increase in ionic concentration in the solution brought about by the hydrolysis reaction will cause the polymer to release additional water.

### K. Catalysts

As noted above, in some instances, a catalyst may be required to initiate the hydrolysis reaction of the chemical hydride with water. Useful catalysts for this purpose include one or more of the transition metals found in Groups IB-VIII of the Periodic Table. The catalyst may comprise one or more of the precious metals and/or may include cobalt, nickel, tungsten carbide or combinations thereof. Ruthenium, ruthenium chloride and combinations thereof are preferred catalysts.

Various organic pigments may also be useful in catalyzing the hydrolysis reaction. Some non-limiting examples of these materials include pyranthrenedione, indanthrene Gold Orange, ditridecyl-3,4,9,10-perylenetetracarboxylic diimide, indanthrene black, dimethoxy violanthrone, quinacridone, 1,4-diketopyrrolo (3,4 C) pyrrole, indanthrene yellow, copper phthalocyanine, 3,4,9,10, perylenetetracarboxylic dianhydride, isoviolanthrone, perylenetetracarboxylic diimide, and perylene diimide. These materials, most of which are not metal based, may offer environmental or cost advantages in certain applications.

The catalysts used in the devices and methodologies disclosed herein may be present as powders, blacks, salts of the active metal, oxides, mixed oxides, organometallic compounds, or combinations of the foregoing. For those catalysts that are active metals, oxides, mixed oxides or combinations thereof, the hydrogen generator may further comprise a support for supporting the catalyst on a surface thereof. In one preferred embodiment, the support comprises an Al/Sr stabilizer disposed on a ceramic matrix material.

The catalyst can be incorporated into the hydrolysis reaction in a variety of ways, including, but not limited to: (i) mixing the catalyst with the hydrogen-containing material first, and then adding water to the hydrogen-containing material/catalyst mixture; (ii) mixing the catalyst with the reactant water first, and then adding this solution/mixture to the hydrogen-containing material; or (iii) combining the hydrogen-containing material with water in the presence of a porous structure that is made of, or contains, a catalyst. The hydrogen generating devices described herein can be adapted to support one or more of these methods for incorporating catalyst into a reactor.

Catalyst concentrations in the hydrogen-generating compositions described herein may vary widely. For some applications, the set catalyst concentration may range between about 0.1 wt % to about 20 wt % active metals based on the total amount of hydride and on the active element or elements in the catalyst. Preferably, the set catalyst concentration may range from between about 0.1 wt % to about 15 wt %, and more preferably, between about 0.3 wt % to about 7 wt %.

### L. Reaction Interface

Various materials may be used in the reaction interface in the hydrogen generators described herein. Preferably, the reaction interface is sufficiently porous to permit the egress of spent hydrogen-containing material (e.g., sodium borate and its hydrates) through the interface, but has sufficient strength to withstand the pressure exerted on it by the compression mechanism within the dispenser. The reaction interface also preferably exhibits sufficient wicking action so that water applied to it will be evenly distributed across its surface.

In some embodiments, this interface may contain multiple components. For example, the interface may contain a first layer of a porous material, such as screening or plastic or wire mesh or foam, and a second layer of a porous wicking agent. In other embodiments, these elements may be combined (for example, a suitable wicking agent may be deposited on the surfaces of a wire or plastic mesh or foam, or the mesh itself may have wicking characteristics). Specific, non-limiting examples of foams that may be used in the reaction interface include aluminum, nickel, copper, titanium, silver, stainless steel, and carbon foams. The surface of the foam may be treated to increase a hydrophilic nature of the surface. Cellular concrete may also be used in the reaction interface.

The temperature of the reaction interface is an important consideration in many of the embodiments of the devices and methodologies disclosed herein, and hence, various heating elements and temperature monitoring or temperature control devices may be utilized to maintain the reaction interface at a desired temperature. For example, when sodium borohydride is utilized as the hydrogen-containing material, the sodium borate reaction byproduct can exist in various hydration states, and the population of each of these states is a function of temperature. Thus, at 40° C., the tetrahydrate species is the principal reaction product, while at 60° C., the dihydrate species is the principal reaction product, and at 100° C., the monohydrate species is the principal reaction product. From a weight penalty standpoint, it is preferable that the reaction interface be maintained at a temperature that will favor the formation of anhydrous or lower hydrate species, since this will require less water to evolve a given volume of hydrogen gas. Moreover, the resulting system will, in many cases, be less prone to the condensation issues described herein, even if no desiccant is employed in the hydrogen gas stream.

The use of chelating agents for the reaction byproducts may also be useful in the devices and methodologies described herein. For example, when sodium borohydride is used as the hydrogen-containing material, a chelating agent may be added to the sodium borohydride, or to the water or other liquid it is reacted with. Such a material binds the sodium borate reaction byproduct and, by occupying ligand sites, prevents or minimizes the formation of hydrates, especially higher order hydrates. Hence, chelating agents may be advantageously used in some instances to reduce the weight penalty associated with the system. Chelating agents, surfactants and other such materials may also be used in the devices and methodologies described herein as solubility enhancing agents.

### M. Control Devices

As previously noted, the hydrogen generators described herein include an inlet into the reaction chamber for the introduction of fluid therein, and an outlet from the reaction chamber for the evolved hydrogen and reaction byproducts to exit the generator. Both the inlet and the outlet of the reaction chamber may comprise various fluid control devices such as, for example, check valves, ball valves, gate valves, globe valves, needle valves, pumps, or combinations thereof. These control devices may further comprise one or more pneumatic or electric actuators and the hydrogen generator may further include a controller in electric or pneumatic communication with one or more of these actuators for controlling the open or closed position of the fluid control devices. Suitable circuitry, chips, and/or displays may also be provided for control purposes.

It will further be appreciated that various types of thermistors and piezoelectric devices may be utilized in the hydrogen generators described herein, both to control the manner and conditions under which reactants are exposed to catalyst, and to control the overall flow of fluids and gases through the hydrogen generator. In some embodiments, these elements and/or the hydrogen generator as a whole may be fabricated as MEMS devices using fabrication techniques that are well known to the semiconductor arts.

### N. Antifoaming Agents

In some embodiments of the devices and methodologies disclosed herein, an antifoaming agent is added to the water that is introduced into the reaction chamber. The use of an antifoaming agent may be advantageous in some applications or embodiments, since the generation of hydrogen during the hydration reaction frequently causes foaming. Hence, by adding an antifoaming agent to the reactant water, the size and weight of the hydrogen generator can be minimized, since less volume is required for disengagement of the gas from the liquid/solids. Polyglycol anti-foaming agents offer efficient distribution in aqueous systems and are tolerant of the alkaline pH conditions found in hydrolyzing borohydride solutions. Other antifoam agents may include surfactants, glycols, polyols and other agents known to those having ordinary skill in the art.

### O. pH Adjusting Agents

Various pH adjusting agents may be used in the devices and methodologies disclosed herein. The use of these agents is advantageous in that the hydration reaction typically proceeds at a faster rate at lower pHs. Hence, the addition of a suitable acid to the fluid mix entering the reaction chamber, as by premixing the acid into the reactant water, may accelerate the evolution of hydrogen gas. Indeed, in some cases, the use of a suitable acid eliminates the need for a catalyst.

Some non-limiting examples of acids that may be suitable for this purpose include, for example, boric acid, mineral acids, carboxylic acids, sulfonic acids and phosphoric acids. The use of boric acid is particularly desirable in some applications, since it aids recycling by avoiding the addition to the reaction byproduct mixture of additional heteroatoms, as would be the case, for example, with sulfuric acid or phosphoric acid. Moreover, boric acid is a solid and can be readily mixed with the hydrogen-containing material if desired; by contrast, other pH adjusting agents must be added to the aqueous solution or other material being reacted with the hydrogen-containing material.

In some embodiments, cation exchange resin materials may also be used as pH adjusting agents. These materials may be added to the hydrogen-containing material in acid form and as high surface area powders.

In other embodiments, carboxylic acids and the like may be used as the pH adjusting agent. These materials may be advantageous in certain applications because they frequently exist in various hydration states, and hence provide additional water to the system. Moreover, some carboxylic acids are capable of undergoing condensation reactions, with the addition of heat, to evolve water. Hence, these materials can aid both with thermal control and by contributing water to the system.

While it may be desirable in some applications of the systems and methodologies disclosed herein to utilize a pH adjusting agent to lower the pH of a hydrogen-generating composition or of a liquid medium that is to be reacted with it, in other applications, the use of a pH adjusting agent may be utilized to increase the pH of the hydrogen-generating composition or the liquid medium with which it reacts. For example, while many hydrogen-generating compositions achieve a higher rate of hydrogen evolution at lower pHs, and while this is desirable in some situations, in other situations, as when it is necessary to transport the hydrogen-generating composition, a high rate of hydrogen evolution may be disadvantageous. In these situations, a pH adjusting agent may be utilized to render the composition more alkaline upon exposure of the material to water or moisture, hence making the composition less reactive and safer to handle.

Some non-limiting examples of alkaline pH adjusting agents include, without limitation, various metal hydroxides, including lithium hydroxide, sodium hydroxide, potassium hydroxide, RbOH, CsOH, ammonium hydroxide, N(CH₃)₄OH, NR₄OH, NR^{a}ₓR^{b}₍₄₋ₓ₎OH, and NR^{a}R^{b}R^{c}R^{d}OH compounds, wherein R^{a}, R^{b}, R^{c} and R^{d} can each independently be hydrogen, alkyl, or aryl groups; various metal oxides, such as Li₂O, Na₂O, K₂O, Rb₂O, Cs₂O; various organic and metal amines; and the like.

### P. Delayed Release Compositions

Various delayed-release compositions may be utilized in the hydrogen-generating materials described herein. Such materials, which may be utilized, for example, to control the reactivity of the hydrogen-generating materials, include, without limitation, slow-release coatings, micro-encapsulations, and/or slowly-dissolving polymer carriers. For example, in some applications, it may be desirable to render the hydrogen-generating composition initially unreactive to water or moisture so that the composition will be safer for handling and transportation. In one particular type of embodiment, this may be accomplished by providing the composition in the form of pellets, granules, or other discrete units whose surfaces are coated with one or more layers of a material or materials that prevent, delay or control the reaction of the composition with moisture, water, or one or more liquid reactants.

One particular example of a delayed release composition that may be used with the hydrogen generating compositions described herein is ethyl cellulose. This material is an excellent film-forming material with strong adhesion that is insoluble in water and that can be used to create a moisture-impermeable barrier over the surfaces of a hydrogen-generating material. It may be used in conjunction with plasticizers such as phthalates, phosphates, glycerides, and esters of higher fatty acids and amides to create films of sufficient flexibility. Ethyl cellulose may be used alone or in combination with water soluble materials such as methyl cellulose as a barrier to delay the reaction of hydrogen-generating materials with water or with other liquid reactions or solutions. Ethyl cellulose coatings may be applied by spray coating or from solutions of appropriate solvents such as cyclohexane.

In some embodiments, ethyl cellulose based films or other suitable materials may be used to form a protective film over hydrogen-generating materials that render these materials safer for shipping and handling. At the point of use, the coated hydrogen-generating material may then be reacted with water or with other liquid reactants or solutions in a controlled or time delayed manner.

In some embodiments, this reaction may be facilitated through the addition of suitable amounts of appropriate solvents and/or surfactants to the liquid reactants or solutions that facilitate the removal of the coating. In the case of ethyl cellulose, for example, if the hydrogen-generating material is being reacted with water or an aqueous solution, suitable amounts of such solvents as ethanol, methanol, acetone, chloroform, ethyl lactate, methyl salicylate, toluene, methylene chloride, or various mixtures of the foregoing may be added to the water or aqueous solution to facilitate the removal of, or the generation of openings in, the coating, thereby allowing the hydrogen-generating material to react. The concentration of these solvents may be manipulated to achieve a desired rate of reaction or to permit the onset of the reaction in a desired time frame.

Alternatively or in combination with the foregoing approach, the coating may be formulated with a sufficient amount of a water soluble material such as methyl cellulose to permit the hydrogen-generating material to react at a desired rate, or in a desired timeframe, upon exposure to water or to the aqueous solution. It will be appreciated that wide variations of release rates or release patterns can be achieved by varying polymer ratios and coating weights.

In other embodiments, a protective coating or coatings may be applied to pellets, granules, or particles of a hydrogen-generating material to render the material safer for handling and transportation. At the point of use, this coating or coatings may then be stripped with a suitable solvent prior to use of the hydrogen-generating material. Since the total amount of coating applied to the hydrogen-generating material may be quite small, and since the complete removal of this coating from the surfaces of the hydrogen-generating material may not be necessary to render the material suitably reactive to water or to other reagents, in many instances the amount of solvent required to render the material suitably reactive may be quite small.

In still other embodiments, coating removal may be achieved at the point of use through mechanical or physical means. For example, the coated particles of the hydrogen generating material may be subjected to mechanical stress so as to rupture the coating, thereby exposing a portion of the underlying hydrogen-generating material for reaction (in such embodiments, the coating may be made sufficiently brittle so that it is frangible). This can be achieved, for example, by grinding or abrading the particles, subjecting the particles to pressure or sound waves, heating the particles (e.g., so as to induce thermal stress in the coating or to melt or soften the coating), irradiating the particles, or the like.

In some embodiments, the hydrogen-generating composition may be mixed with water-generating materials of the type described herein, and the aforementioned mechanical or physical means may be utilized to induce the evolution of water from the water-generating material. The resulting evolution of hydrogen gas may then rupture or cause perforations or disruptions in the coating, thereby exposing a portion of the hydrogen-generating material for further reaction.

In one specific embodiment, a container of the hydrogen-containing material may be provided which is equipped with a pull tab. When the tab is pulled, the associated mechanical action causes the coating on a portion of the particles to be stripped or ruptured, thereby rendering this portion of the particles available for immediate reaction with water or another suitable liquid medium. The remaining particles can be engineered with a timed release profile that is suitable for the particular application.

In other embodiments, the hydrogen-generating composition may be provided with, or interspersed with, conductive filaments or another suitably conductive medium that can generate localized heating of the particles through ohmic resistance. At the point of use, a suitable electric current can be passed through the conductive medium to melt or rupture a portion of the coating on some of the particles. In such embodiments, the coating may comprise a material such as a hydrocarbon wax that has a suitably low melting or softening temperature.

In further embodiments, multiple coatings schemes or compositions may be utilized to produce a plurality of species of coated hydrogen-generating materials that have different reaction rates, or that react in different timeframes, with respect to a given liquid reagent. For example, in one possible embodiment, a plurality of particles species M₁, . . . , Mₙ, wherein n≧2, may be created that have respective coatings C₁, . . . , wherein, for i=1 to n, coating Cᵢ allows a percentage pᵢ of the hydrogen generating material in particle species Mᵢ to react with water or another liquid reagent within tᵢ minutes. The species M₁, . . . , Mₙ may then be mixed in various relative proportions, concentrations or weight percentages such that the resulting mixture has a desired hydrogen generation profile as a function of time.

As noted above, in some embodiments, multiple coatings may be utilized that have different chemical or physical properties. For example, in some embodiments, a modified release coating may be used as an external coating, and a stabilizing coating may be used as an interior coating. In such embodiments, the stabilising coat may act as a physical barrier between the hydrogen-generating material and the modified release coating.

For example, the stabilizing coat may act to slow migration of moisture or solvent between the modified release coating and the hydrogen-generating material. While the stabilizing coat will preferably keep the hydrogen-generating material separated from the modified release coating during storage, the stabilizing coating will preferably not interfere significantly with the rate of release or reaction of the hydrogen-generating material, and therefore may be semi-permeable or even soluble in water or in the liquid medium that the hydrogen-generating material is to be reacted with. Hence, the stabilizing coat may be utilized to keep migration of hydrogen-generating materials to a minimum such that their interaction with coating materials is reduced or prevented, while still allowing for release of hydrogen-generating materials in an aqueous environment.

The stabilizing coat may be any suitable material which creates an inert barrier between the hydrogen-generating material and the modified release coating, and may be water soluble, water swellable or water permeable polymeric or monomeric materials. Examples of such materials include, but are not limited to, hydroxypropylmethyl cellulose, hydroxypropyl cellulose, polyvinyl pyrrolidone, polyethylene glycol or methacrylate based polymers. Preferably the stabilising coat includes a water-soluble polymer that does not interfere with the release of the hydrogen-generating material.

The modified release coating may also be any suitable coating material, or combination of coating materials, that will provide the desired modified release profile. For example, coatings such as enteric coatings, semi-enteric coatings, delayed release coatings or pulsed release coatings may be desired. In particular, coatings may be utilized that provide an appropriate lag in release prior to the rapid release at a rate essentially equivalent to immediate release of the hydrogen-containing material.

In particular, materials such as hydroxypropylmethyl cellulose phthalate of varying grades, methacrylate based polymers and hydroxypropylmethyl cellulose acetate succinate may be utilized in various applications. It is also possible to use a mixture of enteric polymers to produce the modified release coating, or to use a mixture of enteric polymer with a water permeable, water swellable or water-soluble material. Suitable water-soluble or water permeable materials include but are not limited to hydroxypropylmethyl cellulose, hydroxypropyl cellulose, polyvinyl pyrrolidone, polyethylene glycol or mixtures thereof.

Another class of delayed release coatings that may be utilized in some embodiments of the compositions, systems and methodologies described herein are basic materials, such as metal hydroxides or metal or organic amines, including the materials described herein as pH adjusting agents. In the case of hydrogen-generating materials that react with water or aqueous solutions, coatings of these materials on the exterior surfaces of the hydrogen-generating materials can be used to render the hydrogen-generating material essentially unreactive (or reactive at a very slow rate) to moisture or to relatively small amounts of water by rendering the effective pH at the reaction interface (e.g., at the surface of the hydrogen-generating material) sufficiently alkaline. On the other hand, if the amount of coating material is sufficiently small, at the point of use, the amount of water or liquid medium that the hydrogen-generating material is exposed to may be sufficiently large to solvate the alkaline material without significantly affecting the pH of the resulting solution. So long as the coating is selected such that solvation occurs fast enough, the presence of such a coating can be made to have little or no effect on the reactivity of the particles of the hydrogen-generating material at the point of use.

### Q. Wicking Agents

As previously noted, the hydrolysis reaction of a hydride cannot proceed if water is unable to reach the hydride. When pellets of some hydrides, such as LiH, react with water, a layer of insoluble reaction products is formed that blocks further contact of the water with the hydride. The blockage can slow down or stop the reaction.

The devices and methodologies disclosed herein overcome this problem by providing a means for expelling such insoluble products from the reaction zone. However, in some cases, the addition of a wicking agent within the pellets or granules of the hydride or borohydride improves the water distribution through the pellet or granule and ensures that the hydration reaction quickly proceeds to completion. Both salt-like hydrides and covalent hydrides benefit from an effective dispersion of water throughout the hydride. Useful wicking materials include, for example, cellulose fibers like paper and cotton, modified polyester materials having a surface treatment to enhance water transport along the surface without absorption into the fiber, and polyacrylamide, the active component of disposable diapers. The wicking agents may be added to the hydrogen-containing material in any effective amount, preferably in amounts between about 0.5 wt % and about 15 wt % and most preferably, between about 1 wt % and about 2 wt %. It should be noted, however, that, in some applications, variations in the quantity of wicking material added to the hydrogen-containing material do not seem to be significant; i.e., a small amount of wicking material is essentially as effective as a large amount of wicking material.

In some embodiments, one or more wicking agents may be used to create a conduit in which at least a portion of the excess water which may be present in the hydrogen generation reaction byproducts may be returned to another part of the hydrogen generator so that it may be further utilized in the generation of hydrogen gas. Such wicking agents may be disposed, for example, downstream from the catalytic reactor, and may be in fluidic contact with a water reservoir or with the catalytic reactor itself.

### R. Liquid Reactants

While the devices and methodologies described herein have frequently been explained in reference to the use of water as a reactant with the hydride, borohydride, borane, or other hydrogen-containing material, it will be appreciated that various other materials may be used in place of, or in addition to, water. For example, various alcohols may be reacted with the hydrogen-containing material. Of these, low molecular weight alcohols, such as methanol, ethanol, normal and iso-propanol, normal, iso- and secondary-butanol, ethylene glycol, propylene glycol, butylene glycol, and mixtures thereof, are especially preferred. The alcohols may be used either alone or as aqueous solutions of varying concentrations. Liquid reactants containing alcohol may be particularly useful in low temperature applications where the liquid reactant may be subjected to freezing. Various liquid reactants containing ammonia or other hydrogen-containing materials may also be used.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

### LISTING OF ELEMENTS

1: hydrogen generator
3: first reservoir
5: second reservoir
7: regulator
9: first housing
11: second housing
13: hydrogen-containing material
15: casing
17: sub-reservoir
19: liquid medium
21: elastomeric material
23: byproduct receptacle
25: actuator
27: first spring
29: second spring
31: filter
33: reactor
35: resistive heater
37: septum
39: external device
41: first branch
42: restriction
43: second branch
45: hydrogen outlet
47: vent

1. A hydrogen generator, comprising:
a chamber having a hydrogen-containing material disposed therein;
a first fluidic pathway which includes said chamber, said first fluidic pathway further including an upstream portion which is upstream of said chamber, and a downstream portion which is downstream from said chamber; and
a second fluidic pathway which does not include said chamber, and which is adjoined to said downstream portion of said first fluidic pathway;
wherein said first and second fluidic pathways contain a liquid medium in which said hydrogen-containing material is soluble.

2. The hydrogen generator of claim 1, wherein said reservoir is in fluidic communication with each of said first and second fluidic pathways.

3. The hydrogen generator of claim 1, wherein said liquid medium is an aqueous solution of sodium hydroxide.

4. The hydrogen generator of claim 1, wherein the hydrogen-containing material is sodium borohydride, and wherein the liquid medium is an aqueous alkaline solution.

5. The hydrogen generator of claim 4, wherein the liquid medium is aqueous solution of sodium hydroxide.

6. The hydrogen generator of claim 1, wherein said chamber comprises an elastomeric material.

7. The hydrogen generator of claim 1, further comprising a first reservoir containing said liquid medium, said first reservoir being in fluidic communication with at least one of said first and second fluidic pathways.

8. The hydrogen generator of claim 7, wherein said first reservoir is in fluidic communication with both of said first and second fluidic pathways.

9. The hydrogen generator of claim 7, wherein said first reservoir contains first and second sub-reservoirs, and wherein each of said first and second sub-reservoirs comprises a portion of said liquid medium disposed within an elastomeric chamber.

10. The hydrogen generator of claim 9, wherein each of said first and second sub reservoirs comprises an elastomeric tube.

11. The hydrogen generator of claim 9, further comprising an inlet which is in fluidic communication with said first and second sub-reservoirs, and by which said first and second sub-reservoirs may be charged with said liquid medium.

12. The hydrogen generator of claim 7, wherein said chamber is disposed within a second reservoir, and wherein the pressure inside of said first and second reservoirs is essentially equal.

13. The hydrogen generator of claim 1, further comprising a catalytic reactor which is in fluidic communication with said first and second fluidic pathways downstream from the point at which said first and second fluidic pathways are adjoined.

14. The hydrogen generator of claim 13, wherein the concentration of said hydrogen-containing material in said liquid medium is lower immediately downstream from the point at which said first and second fluidic pathways are adjoined.

15. The hydrogen generator of claim 14, wherein the point at which said first and second fluidic pathways are adjoined is upstream from said catalytic reactor.

16. The hydrogen generator of claim 7, further comprising a catalytic reactor which is in fluidic communication with said first and second fluidic pathways downstream from the point at which said first and second fluidic pathways are adjoined, and wherein said catalytic reactor is in fluidic communication with a byproduct receptacle disposed within said first reservoir.

17. The hydrogen generator of claim 16, wherein said byproduct receptacle comprises a hydrogen permeable material.

18. The hydrogen generator of claim 17, further comprising a catalytic hydrogen recombiner which is adapted to convert hydrogen gas to water in the presence of oxygen, and wherein said hydrogen recombiner is in fluidic communication with said first reservoir by way of a pressure activated valve.

19. The hydrogen generator of claim 1, further comprising a regulator adapted to control the flow of fluid into said first fluidic pathway.

20. The hydrogen generator of claim 19, wherein said regulator is also adapted to control the flow of fluid into said second fluidic pathway.

21. The hydrogen generator of claim 20, wherein said regulator comprises an actuator whose movement is controlled by first and second opposing springs.

22. A hydrogen generator, comprising:
a first reservoir containing a liquid medium;
a second reservoir containing a hydrogen-containing material, said second reservoir being in fluidic communication with said first reservoir by way of a first fluidic pathway; and
a second fluidic pathway which is in fluidic communication with said first reservoir, and which is also in fluidic communication with said first fluidic pathway at a point downstream from said second reservoir.

23. The hydrogen generator, comprising:
a chamber having a hydrogen-containing material disposed therein;
a first reservoir containing a liquid medium which dissolves said hydrogen-containing material;
a reactor adapted to react a solution of the hydrogen-containing material in the liquid medium to generate hydrogen gas;
a first fluidic pathway connecting said first reservoir to said chamber;
a second fluidic pathway connecting said chamber to said reactor; and
a third fluidic pathway connecting said first reservoir to said second fluidic pathway at a point downstream from said chamber.

24. The hydrogen generator of claim 23, wherein the walls of said chamber comprise an elastomeric material.

25. A method for generating hydrogen gas, comprising:
dissolving a hydrogen-containing material in a first liquid medium to produce a first solution;
diluting the first solution to produce a second solution; and
reacting the second solution in the presence of a catalyst to generate hydrogen gas.

26. (canceled)

27. (canceled)

28. (canceled)

29. (canceled)

30. A hydrogen generator, comprising:
a pressurized chamber;
a flexible envelope having a hydrogen-containing material disposed therein; and
a reservoir having a liquid medium disposed therein which dissolves the hydrogen-containing material, said reservoir being in fluidic communication with said envelope.

31. (canceled)

32. (canceled)

33. (canceled)

34. (canceled)

35. (canceled)

36. (canceled)

37. (canceled)

38. (canceled)

39. (canceled)

40. (canceled)
